(19) United States
(12) Patent Application Publication
(10) Pub. No.: US 2019/0388996 A1
(43) Pub. Date: Dec. 26, 2019

(54) PROJECTION WELDING MACHINE

(71) Applicant: AUTOIT CO.,LTD, Seoul (KR)

(72) Inventors: Myung Hwan Jeong, Seoul (KR); Hyo Jin Jang, Valley, AL (US)

(21) Appl. No.: 16/481,777

(22) PCT Filed: Jan. 31, 2017
(86) PCT No.: PCT/KR2017/001006

§ 371 Date: Jul. 29, 2019

(51) Int. Cl. B23K 11/14; B23K 11/25; B23K 11/36

(52) U.S. Cl. CPC B23K 11/14; B23K 11/36; B23K 11/253

(57) ABSTRACT

The present disclosure relates to a projection welding machine, and more particularly, to a projection welding machine for avoiding an accident in which an operator's hand gets caught between an upper electrode unit and a lower electrode unit, and preventing a fault in welding operation from occurring due to incorrect seating of a nut on the lower electrode unit.

### TECHNICAL FIELD

The present disclosure relates to a projection welding machine, and more particularly, to a projection welding machine for avoiding an accident in which an operator's hand gets caught between an upper electrode unit and a lower electrode unit, and preventing a fault in welding operation from occurring due to incorrect seating of a nut on the lower electrode unit.

### BACKGROUND ART

In general, to mount decorative components on body panels of a vehicle, it is necessary to weld nuts to the body panels. In this instance, the commonly used welding machine is a projection welding machine. The projection welding machine is a machine used to perform resistance welding with high heating efficiency by putting a target to be welded, for example, a nut having a protrusion on materials, moving an upper electrode unit to a lower electrode unit, and concentrating current and pressure on the protrusion.

As shown in FIG. 3, a conventional projection welding machine includes an upper electrode unit 11, a lower electrode unit 12 and a nut feeder 13 to supply a nut having a protrusion to a projection welder. Although not shown in FIG. 3, an inspection start switch for signaling that allows the projection welding machine to operate is connected. For example, as shown in FIG. 4, the projection welding machine welds the nut 21 to the body panel 20 for assembling the components of the vehicle mounted on the lower electrode unit 23.

However, when using the conventional projection welding machine, an operator generally holds the body panel with his/her hand and welds while moving the upper electrode unit to the lower electrode unit with the inspection start switch being pressed down, and repeats this process. When using the projection welding machine, the operator often presses down the inspection start switch with the foot by mistake with his/her hand put on the projection welding machine, so the operator's finger loss or injury accidents often occur. Additionally, a fault in welding operation occurs due to incorrect seating of the nut on the lower electrode unit.

### DISCLOSURE OF THE INVENTION

### Technical Problem

To solve the conventional problem, the present disclosure provides a projection welding machine that operates when a lower electrode unit has no foreign matter and a nut's seated pose is normal.

The present disclosure further provides a projection welding machine that can prevent accidents caused by the operation of the cylinder to move up and down an upper electrode unit.

The present disclosure further provides a projection welding machine that can be operated by manual manipulation when an emergent situation occurs.

The present disclosure further provides a projection welding machine that allows an operator to intuitively recognize whether the current operation is being safely performed.

### Technical Solution

To solve the above-described problem, a projection welding machine according to the present disclosure includes: an upper holder including a cylinder operation unit to move up and down an upper electrode unit and a cylinder location sensor to detect a location of a cylinder; a lower holder including a lower electrode unit opposite the upper electrode unit of the upper holder; at least one first distance sensor fixedly installed at the upper holder to compare a measured value obtained by measuring a distance from materials placed on the lower holder using a laser with a setting value set by a user, and when a difference of absolute value between the measured value and the setting value is equal to or less than a reference value, generate a relay operation signal; a first relay in which contact points are connected according to the relay operation signal of the first distance sensor; a nut feeder including a nut supply unit to supply a nut to the lower electrode unit of the lower holder; at least one second distance sensor fixedly installed at the nut feeder to compare a first measured value obtained by measuring a distance from the materials placed on the lower holder using a laser with a second setting value set by the user, and when a difference of absolute value between the first measured value and the second setting value is equal to or less than a reference value, generate a relay operation signal; a second relay in which contact points are connected according to the relay operation signal of the second distance sensor; and an inspection start switch that is turned on or off by the user's foot manipulation, wherein the inspection start switch, the first relay and the second relay are connected in series, and when the inspection start switch is turned on in contact point connection between the first relay and the second relay, the nut supply unit of the nut feeder and the cylinder operation unit of the upper holder operate.

Additionally, the upper holder of the projection welding machine according to the present disclosure further includes a cylinder location sensor to receive and store an input of a third setting value for a cylinder operation distance by the user manipulation, compare a measured value of the cylinder operation distance with the third setting value, and when the measured value is larger than the third setting value, generate a relay operation signal, a third relay connected in series to the first and second relays, and in which contact points are connected according to the relay operation signal of the cylinder location sensor, and a fourth relay connected in parallel to the first, second and third relays, and in which connection between contact points is released according to the relay operation signal of the cylinder location sensor, and the third setting value is smaller than the first setting value.

Additionally, the projection welding machine according to the present disclosure further includes a manual button to output a bypass relay operation signal by the user manual manipulation, and a bypass relay connected in parallel to the first, second and third relays, and in which contact points are connected according to the bypass relay operation signal of the manual button.

Additionally, the projection welding machine according to the present disclosure further includes a first indicator lamp that lights up when the contact points in the first relay are connected, and a second indicator lamp that lights up when the contact points in the second relay are connected.

### Advantageous Effects

According to the projection welding machine having the above-described configuration, there are the following effects:

First, with the distance sensor using a laser and the relay connection structure that operates with it, the projection welding machine is implemented to operate the nut supply unit of the nut feeder and the cylinder operation unit of the upper holder only when an operation environment of the lower electrode unit is normal, so when the lower electrode unit has a foreign matter (in particular, an operator's hand) or the nut's seated pose is bad, the machine does not operate.

Second, with the cylinder location sensor and the relay connection structure that operates with it, it is possible to prevent accidents caused by the operation of the cylinder when the cylinder operates by the operator's pressing down the inspection start switch with the foot by mistake.

Third, with the manual button and the bypass relay connection structure, when the machine does not operate due to a failure in the distance sensor using a laser, the operator can operate the machine by using the inspection start switch and the manual button.

Fourth, when the relay operates, the indicator lamp indicates it by light, and through this, the operator can intuitively recognize whether the current operation is being safely performed.

### BRIEF DESCRIPTION OF THE DRAWINGS

FIG. 1 is an exemplary diagram illustrating a configuration of a projection welding machine according to the present disclosure.

FIG. 2 is an exemplary diagram illustrating an electrical connection relationship of a projection welding machine according to the present disclosure.

FIG. 3 is a schematic diagram showing a conventional projection welding machine.

FIG. 4 is a diagram showing a nut welded to a panel of a vehicle using the conventional projection welding machine of FIG. 3.

### MODE FOR CARRYING OUT THE INVENTION

It should be noted that the present disclosure may have various modifications and many embodiments, and particular embodiments will be illustrated in the accompanying drawings and specified in the detailed description. However, it should be understood that this is not intended to limit the present disclosure to particular embodiments, and rather, covers all modifications, equivalents or substituents included in the spirit and scope of the present disclosure.

The terms as used herein are only used to describe particular embodiments, but not intended to limit the present disclosure. Unless the context clearly indicates otherwise, the singular includes the plural.

Hereinafter, the preferred embodiments of the present disclosure will be described in detail with reference to the accompanying drawings.

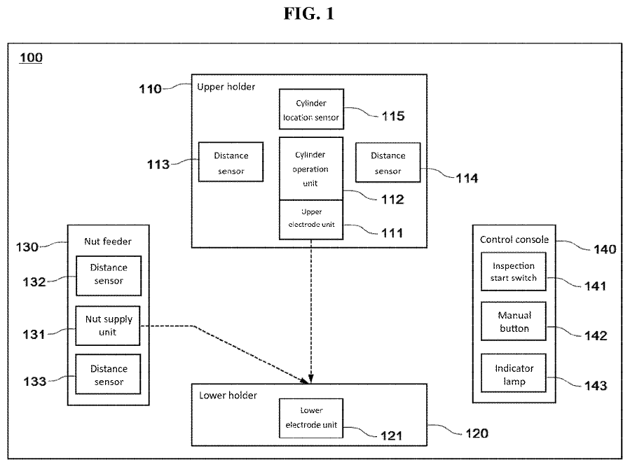

A projection welding machine according to the present disclosure is implemented, as shown in FIG. 1, including an upper holder 110, a lower holder 120, a nut feeder 130, and a control console 140 that can be manipulated by an operator.

The upper holder 110 may be implemented including a cylinder operation unit 112 to move up and down an upper electrode unit 111, at least one distance sensor 113, 114 and a cylinder location sensor 115. The cylinder operation unit 112 may be implemented including a cylinder, a cylinder case, a piston and a working fluid supply unit.

The distance sensors 113, 114 sense an object by measuring a distance taken for an emitted laser to return after bouncing off of the object. The distance sensors 113, 114 may be fixedly installed on each of the left side and the right side of the upper holder 110. The distance sensors 113, 114 measure the distance from materials, for example, a vehicle panel, placed on the lower holder 120. The distance sensors 113, 114 may be implemented to allow the operator to preset the distance. The distance sensors 113, 114 compare the measured value with the setting value set by the user, and when a difference of absolute value between the measured value and the setting value is equal to or less than a reference value, generate a relay operation signal.

The cylinder location sensor 115 may receive and store an input of a setting value for a cylinder operation distance by the user manipulation. The cylinder location sensor 115 compares the measured value of the cylinder operation distance with the setting value, and when the measured value is larger than the setting value, generates a relay operation signal.

The lower holder 120 includes a lower electrode unit 121 opposite the upper electrode unit 111 of the upper holder 110. The lower holder 120 may be implemented further including a cylinder operation unit to move up and down the lower electrode unit 121.

The nut feeder 130 includes a nut supply unit 131 to supply a nut to the lower electrode unit 121 of the lower holder 120 and at least one distance sensor 132, 133. The nut feeder 130 is installed on one side of the projection welding machine.

The distance sensors 132, 133 are each fixedly installed at different locations with respect to the nut feeder 130. The distance sensors 132, 133 measure the distance from materials, for example, the vehicle panel, placed on the lower holder 120. The distance sensors 132, 133 may be implemented to allow the operator to preset the distance. The distance sensors 132, 133 compare the measured value with the setting value set by the user, and when a difference of absolute value between the measured value and the setting value is equal to or less than a reference value, generate a relay operation signal.

The control console 140 is a device that allows the user to operate the upper holder 110, the lower holder 120 and the nut feeder 130. The control console 140 may be implemented including an inspection start switch 141 that is turned on or off by the user's foot manipulation, a manual button 143 to output a bypass relay operation signal by the user manual manipulation, and an indicator lamp 143.

The distance sensors 113, 114, 132, 133 using a laser installed at the upper holder 110 and the nut feeder 130 have different installation locations and laser irradiation orientations. This is to cover all areas that need monitoring so as to prevent accidents. The number of distance sensors may be different in each product.

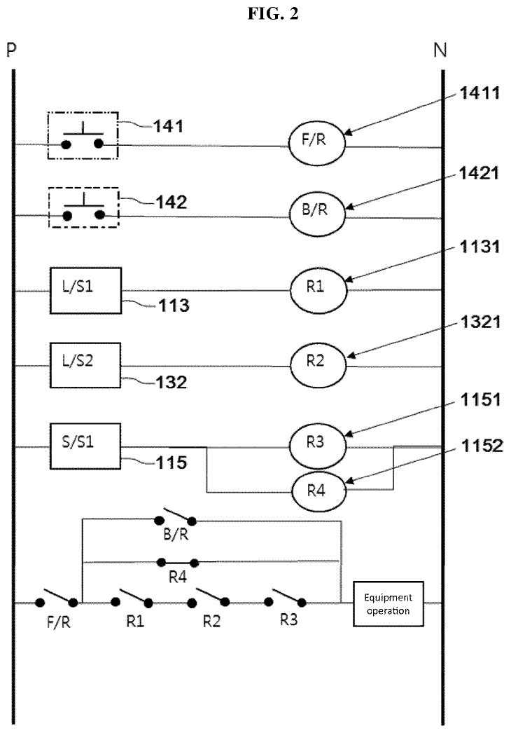

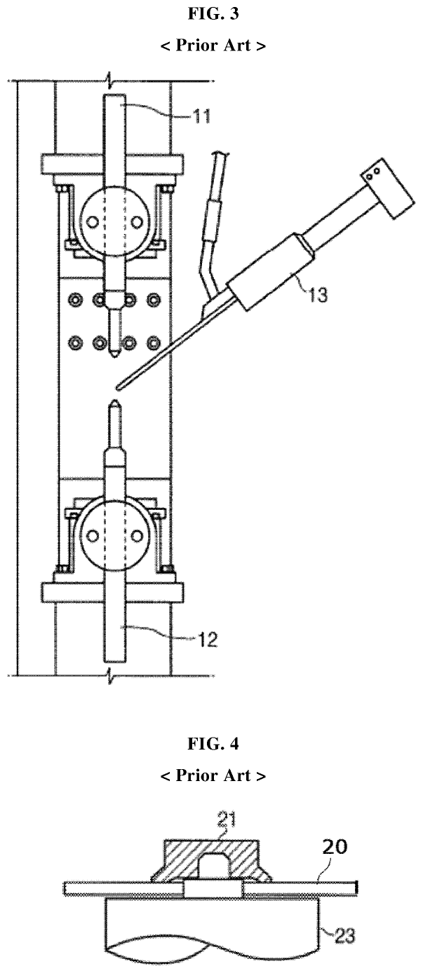

FIG. 2 is an exemplary diagram illustrating an electrical connection relationship of the projection welding machine according to the present disclosure. In FIG. 2, the reference number 141 is the inspection start switch, the reference number 142 is the manual button, the reference numbers 113 and 132 are the distance sensors using a laser, the reference number 115 is the cylinder location sensor, the reference number 1411 is the inspection start switch operation identifying relay F/R in which contact points are connected according to the relay operation signal of the inspection start switch, the reference number 1421 is the manual button operation identifying relay B/R in which contact points are connected according to the relay operation signal of the manual button, the reference number 1131 is the first distance sensor operation identifying relay R1 in which contact points are connected according to the relay operation signal of the distance sensor 113, the reference number 1321 is the second distance sensor operation identifying relay R2 in which contact points are connected according to the relay operation signal of the distance sensor 132, the reference number 1151 is the first cylinder location sensor operation identifying relay R3 in which contact points are connected according to the relay operation signal of the cylinder location sensor 115, and the reference number 1152 is the second cylinder location sensor operation identifying relay R4 in which connection between contact points is released according to the relay operation signal of the cylinder location sensor 115.

Referring to FIG. 2, the inspection start switch 141, the first distance sensor operation identifying relay R1 and the second distance sensor operation identifying relay R2 are connected in series. When the inspection start switch 141 is turned on in contact point connection between the first distance sensor operation identifying relay R1 and the second distance sensor operation identifying relay R2, equipment including the nut supply unit of the nut feeder and the cylinder operation unit of the upper holder operate.

Additionally, as shown in FIG. 2, the inspection start switch 141, the first distance sensor operation identifying relay R1, the second distance sensor operation identifying relay R2 and the first cylinder location sensor operation identifying relay R3 may be connected in series.

Additionally, as shown in FIG. 2, the manual button operation identifying relay B/R is a sort of bypass relay connected in parallel to the first distance sensor operation identifying relay R1, the second distance sensor operation identifying relay R2 and the first cylinder location sensor operation identifying relay R3. Accordingly, even when the distance sensors 113, 132 are out of order and the machine does not operate, the operator can operate the machine by using the inspection start switch 141 and the manual button 142.

Additionally, as shown in FIG. 2, the second cylinder location sensor operation identifying relay R4 is connected in parallel to the first distance sensor operation identifying relay R1, the second distance sensor operation identifying relay R2 and the first cylinder location sensor operation identifying relay R3. Accordingly, it is possible to prevent accidents caused by the operation of the cylinder when the cylinder operates by the operator's pressing down the inspection start switch 141 with the foot by mistake.

While the present disclosure has been hereinabove described with reference to the embodiments, those having ordinary skill in the corresponding technical field will be able to understand that various modifications and changes may be made thereto without departing from the spirit and scope of the present disclosure set forth in the appended claims.

### DESCRIPTION OF REFERENCE NUMERALS

141: Inspection start switch
142: Manual button
113, 132: Distance sensor
115: Cylinder location sensor
1411: Inspection start switch operation identifying relay
1421: Manual button operation identifying relay
1131: First distance sensor operation identifying relay
1321: Second distance sensor operation identifying relay
1151: First cylinder location sensor operation identifying relay
1152: Second cylinder location sensor operation identifying relay

### MODE FOR INVENTION

The mode for the present disclosure is described in the best mode of the present disclosure as described above.

### INDUSTRIAL APPLICABILITY

The technology according to the present disclosure is applicable in welding machine.

1. A projection welding machine, comprising:
an upper holder including a cylinder operation unit to move up and down an upper electrode unit and a cylinder location sensor to detect a location of a cylinder;
a lower holder including a lower electrode unit opposite the upper electrode unit of the upper holder;
at least one first distance sensor fixedly installed at the upper holder to compare a measured value obtained by measuring a distance from materials placed on the lower holder using a laser with a setting value set by a user, and when a difference of absolute value between the measured value and the setting value is equal to or less than a reference value, generate a relay operation signal;
a first relay in which contact points are connected according to the relay operation signal of the first distance sensor;
a nut feeder including a nut supply unit to supply a nut to the lower electrode unit of the lower holder;
at least one second distance sensor fixedly installed at the nut feeder to compare a first measured value obtained by measuring a distance from the materials placed on the lower holder using a laser with a second setting value set by the user, and when a difference of absolute value between the first measured value and the second setting value is equal to or less than a reference value, generate a relay operation signal;
a second relay in which contact points are connected according to the relay operation signal of the second distance sensor; and
an inspection start switch that is turned on or off by the user's foot manipulation,
wherein the inspection start switch, the first relay and the second relay are connected in series, and when the inspection start switch is turned on in contact point connection between the first relay and the second relay, the nut supply unit of the nut feeder and the cylinder operation unit of the upper holder operate.

2. The projection welding machine of claim 1, wherein the upper holder further including:
a cylinder location sensor to receive and store an input of a third setting value for a cylinder operation distance by the user manipulation, compare a measured value of the cylinder operation distance with the third setting value, and when the measured value is larger than the third setting value, generate a relay operation signal;
a third relay connected in series to the first and second relays, and in which contact points are connected according to the relay operation signal of the cylinder location sensor; and
a fourth relay connected in parallel to the first, second and third relays, and in which connection between contact points is released according to the relay operation signal of the cylinder location sensor,
wherein the third setting value is smaller than the first setting value.

3. The projection welding machine of claim 1, further comprising:
a manual button to output a bypass relay operation signal by the user manual manipulation; and
a bypass relay connected in parallel to the first, second and third relays, and in which contact points are connected according to the bypass relay operation signal of the manual button.

4. The projection welding machine of claim 1, further comprising:
a first indicator lamp that lights up when the contact points in the first relay are connected; and
a second indicator lamp that lights up when the contact points in the second relay are connected.
